(19) United States
(12) Patent Application Publication
(10) Pub. No.: US 2023/0089361 A1
(43) Pub. Date: Mar. 23, 2023

(54) System and Method for a Confirmation System

(71) Applicant: Package Portal Inc., Phoenix, AZ (US)

(72) Inventors: Jeremy G. Whitley, Mesa, AZ (US); Gabriel J. Chaney, Phoenix, AZ (US)

(21) Appl. No.: 17/483,659

(22) Filed: Sep. 23, 2021

(51) Int. Cl. G06Q 10/08; G06Q 50/30; G06Q 30/02; G06Q 20/36

(52) U.S. Cl. CPC G06Q 10/0833; G06Q 50/30; G06Q 30/0207; G06Q 20/367; G06Q 2220/00

(57) ABSTRACT

A system and method is disclosed for confirming delivery of a parcel. The parcel may be shipped by a merchant, such as through a transport service. A tracking number may be generated to assist the merchant, the transport service, and the recipient in tracking the parcel. The transport service may deliver the parcel to the recipient. The recipient may receive the parcel may utilizing an electronic device-based confirmation app. The recipient may enter the tracking number into the confirmation app. Upon successful validation of the tracking number, the recipient may receive crypto tokens as a reward for participation.

### FIELD

The present disclosure generally relates to parcel delivery confirmation, and more particularly to a contactless confirmation system.

### BACKGROUND

Delivery, mail, and/or courier services (hereinafter “transport services”) have existed since as early as the Persian Empire in the 6^{th} century BCE. Later, the Roman empire instituted cursus publicus, the public way, to transport messages and taxes throughout their empire. Even Genghis Khan, who is thought of as a warrior-ruler, established a system of postal or relay stations every 20 to 30 miles to facilitate communication throughout his empire. More recently, the United States formed the U.S. Postal Service in 1775 during the Second Continental Congress.

The pony express, railroads, and a number of other modern inventions have further refined and developed the speed and sophistication with which transport services can get a parcel from one place to another. In the recent past, public and private transport services have relied on various systems to track hundreds of millions of transactions.

Nevertheless, no service or system is perfect, particularly where those services rely on employees to faithfully execute their jobs without error. Further, even the systems themselves are subject to error, such as due to system crashes, hackers, software coding, and so forth. Therefore, a need exists for a method to authenticate delivery of articles to ensure that every transaction results in a successful transport of an article.

### SUMMARY

A confirmation system for confirming delivery of a parcel to a consumer comprises a remote system for providing metadata corresponding to the parcel, and a service provider system having storage for collecting the metadata from the remote system, wherein the service provider system is configured to receive metadata from the consumer to confirm delivery of the parcel.

A method of confirming delivery of a parcel to a consumer comprises receiving metadata corresponding to the parcel from the consumer to a service provider system, requesting and receiving metadata corresponding to the parcel from a merchant system to the service provider system, and validating the metadata received from the merchant system against the metadata received from the consumer.

A method of confirming delivery of a parcel to a consumer comprises receiving metadata corresponding to the parcel from the consumer to a service provider system, requesting and receiving metadata corresponding to the parcel from a transport system to the service provider system, and validating the metadata received from the transport system against the metadata received from the consumer.

### BRIEF DESCRIPTION OF THE DRAWINGS

Various aspects and advantages will become apparent upon review of the following detailed description and upon reference to the drawings in which:

FIG. 1 illustrates a system for confirming parcel deliveries;

FIG. 2 illustrates a method for connecting a user to a confirmation system provided by a service provider;

FIG. 3 illustrates a method for affecting the transport of an article;

FIG. 4 illustrates a method for confirming delivery of an article.

### DETAILED DESCRIPTION

The following disclosure includes a system and method for confirming delivery (e.g., confirming delivery of an article transported as part of a purchase transaction). For each purchase transaction, the system may collect and/or provide information about the purchase transaction, the article, and/or the transport (the “metadata”) to a seller of articles (e.g., a merchant), a transport service (e.g., a courier), and a buyer of articles (e.g., a consumer). The confirmation system may enable the buyer of articles to confirm receipt of the article(s). The confirmation system may provide rewards to the buyer of articles to incentivize the buyer of articles to participate in the confirmation system. The transport service and the seller of articles may receive metadata to incentivize participation in the confirmation system.

One or more articles may be included in each parcel to be transported, and one or more parcels may be included in each purchase transaction. In general, articles sent in transport may include any physical or tangible thing that has dimensions, density, and/or weight, no matter how big or how small. Yet articles may also include intangible things, such as assets, communications, and/or other things that can be sent electronically. The confirmation system may facilitate confirmation of receipt of any article, of any parcel containing one or more articles, and/or of any purchase transaction including one or more parcels.

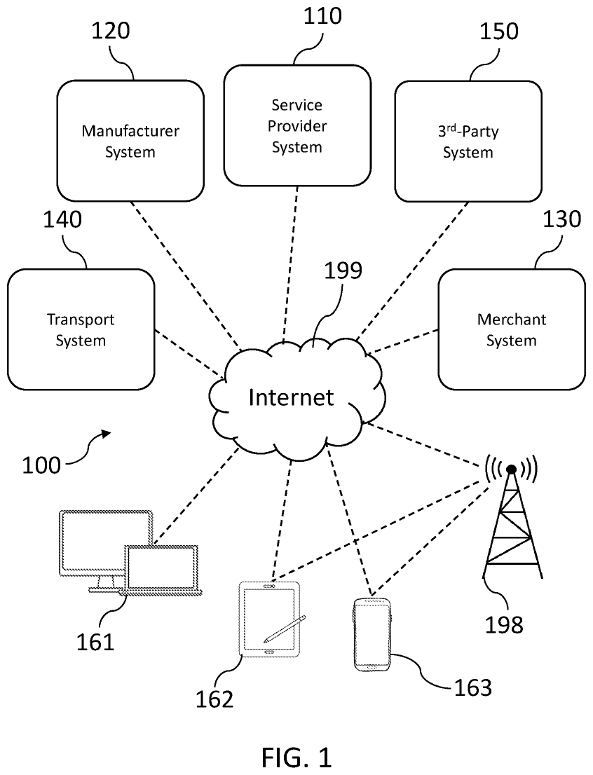

FIG. 1 illustrates a confirmation system 100 which operates in accordance with the principles outlined in this disclosure. The confirmation system 100 is facilitated by a service provider system 110. Service provider system 110 may collect metadata for each purchase transaction, for each parcel, and/or for each article. Metadata may be collected and retained in a storage medium (e.g., a server, a hard drive, or other electronic storage system). The metadata for each purchase transaction, parcel, or article may be associated with a block chain (e.g., with corresponding metadata stored in blocks and chained together). As additional metadata is collected for a particular block chain, it may be entered into a fresh block and chained together with the previous blocks of metadata (e.g., with metadata chained together in chronological order).

Metadata may include the make, model, size, weight, product number, or other information that describes an article (e.g., information collected by a manufacturer of an article). Metadata may further include a purchase amount, a purchase location, a store number, a date of purchase, or other information about a purchase transaction (e.g., information collected by a reseller/merchant of one or more articles). Metadata may further include an order processing date, an order processing number, a bar code, a tracking number a ship date, a delivery date, or other information about the transport of a parcel (e.g., information collected by a transport service and/or a merchant). Metadata may further include a validation information, a receipt date, a satisfaction rating, or other information about the receipt of a parcel (e.g., information collected by a consumer). The above examples are in no way intended to be a dispositive list, and a person of ordinary skill in the art will appreciate that additional metadata may be collected and stored in the confirmation system 100.

Service provider system 110 may collect metadata from other remote systems. Service provider system 110 may collect metadata from one or more manufacturers (e.g., from a manufacturer system 120), from one or more merchants (e.g., from a merchant system 130), and/or from one or more transport services (e.g., from a transport system 140). Service provider system 110 may collect metadata from a third-party collection service (e.g., from a 3′-party system 150), where the third-party collection service collects metadata from the one or more manufacturers, the one or more merchants, and/or the one or more transport services. Metadata may be transferred to service provider system 110 instantaneously when generated, in periodic batches, or when requested by service provider system 110.

While it is conceivable that metadata may be transferred to service provider system 110 using traditional methods (e.g., mail, fax, telephone), it is highly preferrable that metadata be transferred to service provider 110 using known electronic software and hardware (e.g., email, data feeds, and other forms of electronic communication). As exemplified in FIG. 1, electronic communication between service provider system 110 and other elements of confirmation system 100 (e.g., manufacturer system 120, merchant system 130, transport system 140, 3^{rd}-party system 150) may be performed wirelessly, such as through the internet 199. A person of ordinary skill in the art will appreciate that wireless communication throughout a geographic region is more complex than represented and may incorporate both wired and wireless communication. Nevertheless, the stippled lines in FIG. 1 are meant to represent communication between the various elements as represented.

In the lifecycle of an article transfer, a consumer (e.g., a user of confirmation system 100) may purchase an article using known online means, such as through the use of an online marketplace, website, or other electronic resource. The merchant from whom the article was purchased may prepare the article for shipment (e.g., as a parcel), and may deliver the parcel to the consumer. The merchant may transfer custody of the parcel to a transport service, and the transport service may deliver the parcel to the consumer. Upon receipt of the parcel, the consumer may utilize the confirmation system 100 to confirm receipt of the parcel, and/or of the article.

To that end, the consumer may communicate with the service provider system 110 through the use of one or more electronic devices, or smart devices (e.g., a computer/laptop 161, a tablet 162, a cellular phone 163, and so forth). The electronic devices may be configured to communicate using a wired or wireless connection, such as through internet 199 and/or through a cellular network 198. Cellular network 198 may relay communications directly or indirectly to and from service provider system 110 using known methods. The consumer may initiate communication with the service provider system 110.

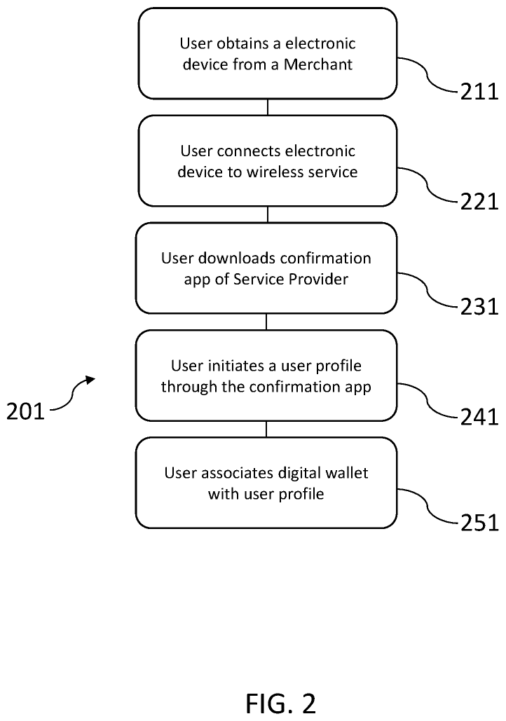

FIG. 2 illustrates a method 201 for connecting a user to a confirmation system (e.g., confirmation system 100 of FIG. 1). The confirmation system may include application software (a “confirmation app”), which may be provided by a service provider to enable interaction with the confirmation system. The app may be available for purchase and/or download from known app resource pages (e.g., app stores), and may be downloadable by any one or more of manufacturers, merchants, transport services, third-party collection services, and consumers (each a “user” of the confirmation system).

In step 211, a user may obtain an electronic device from a merchant (e.g., via purchase). Thus, any of the systems 120, 130, 140, 150 of FIG. 1 may incorporate one or more electronic devices to facilitate communication with the confirmation system.

In step 221, a user may connect the electronic device to a wireless network (e.g., internet 199 or cellular network 198 of FIG. 1). A person of ordinary skill in the art will appreciate that each electronic device may come with or be equipped with operating systems and other software to facilitate standard operating functions, such as software and hardware to connect the electronic device to a wireless network.

In step 231, a user may purchase, obtain, download and/or install the confirmation app. A person of ordinary skill in the art will appreciate that known software and hardware may be utilized to equip an electronic device with any app.

In step 241, a user may initiate a user profile through the confirmation app. The user may “sign up” for the services provided by the confirmation app and/or the confirmation system. The user may be required to enter personally identifiable information, such as name, address, phone number, and so forth. If a business, the user may be required to enter business information and contact information for one or more individuals employed by the business. After creation of the user profile, the user's electronic device may facilitate any of the communication described with respect to FIG. 1, and may further enable participation by the user in the various features and functions of the confirmation system.

In step 251, the user (e.g., the merchant system 130 of FIG. 1, or a consumer communicating with an electronic device 161, etc.) may associate a digital wallet with the user profile. Though discussed in greater detail below, the digital wallet may enable the user to give and/or receive awards for participating in the confirmation system.

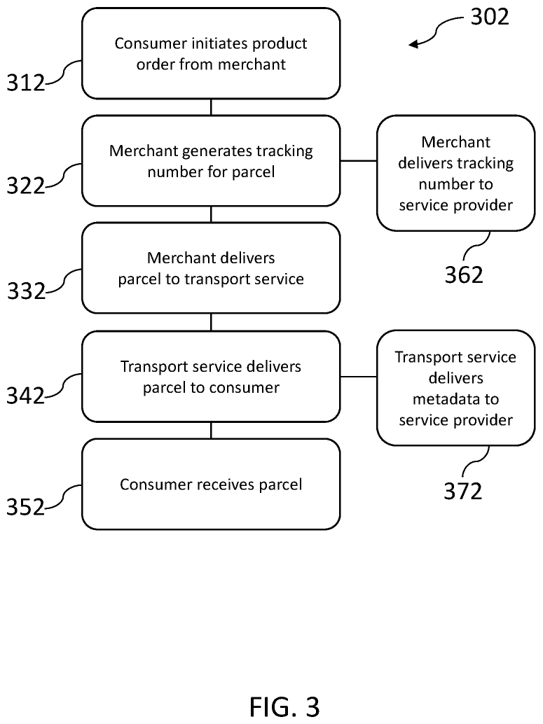

FIG. 3 illustrates a method 302 for affecting the transport of an article (e.g., of one or more parcels containing one or more articles).

In step 312, a consumer may initiate a product order by purchasing an article from a merchant.

In step 322, the merchant may generate a tracking number, or any other type of uniquely identifiable number that is associated with the article and/or parcel to be shipped. In general, it is understood that the tracking number, or other unique identifier, may be generated directly by the merchant, or may be generated by the transport service used by the merchant and collected by the merchant as part of the shipment transaction.

In step 332, the merchant may deliver the article and/or the parcel containing the article to a transport service (e.g., a courier).

In step 342, the transport service may deliver the article and/or the parcel containing the article to the consumer.

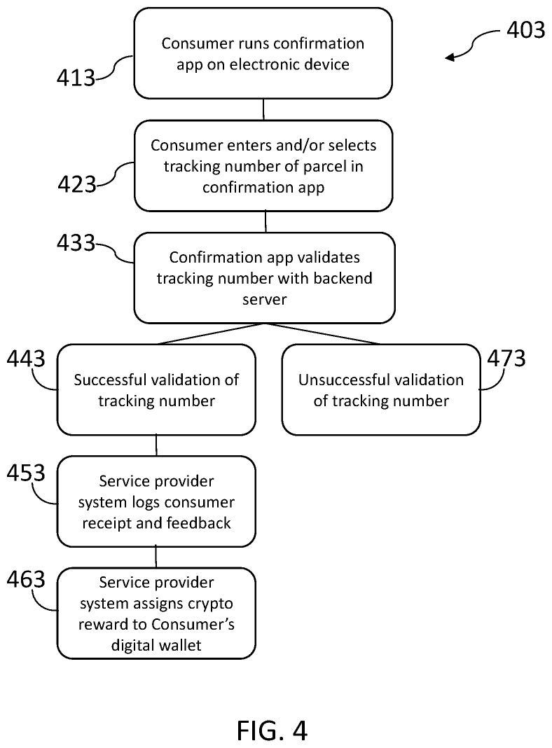

In step 352, the transport consumer may receive the article and/or the parcel as further described in this disclosure (e.g., as represented by method 403 of FIG. 4).

In step 362, the merchant may deliver the tracking number, or other unique identifier, and other metadata in its possession to a service provider or to the service provider system (e.g., service provider system 110 of FIG. 1) as heretofore described. The service provider may request the unique identifier from the merchant, such as before or after step 352.

In Step 372, the transport service may deliver any metadata in its possession to the service provider system. The service provider may request the metadata from the transport service, such as before or after step 352.

FIG. 4 illustrates a method 403 for confirming delivery of an article and/or a parcel using a confirmation system (e.g., confirmation system 100 of FIG. 1). A consumer may receive the parcel and confirm delivery of the parcel (e.g., step 352 of FIG. 3). Thus, method 403 may represent a number of steps or sub-steps for a consumer to receive and confirm delivery of the parcel. While not exclusively required, it is generally understood that the various steps in method 403 occur or are performed after the earlier steps of method 302 (e.g., steps 312, 322, 332, and 342), whereas steps 362, 372 of method 302 may occur prior to or during the steps of method 403.

In step 413, the consumer may run a confirmation app on their electronic device (e.g., by starting the confirmation app, clicking on the confirmation app, opening the confirmation app, or otherwise causing the confirmation app to begin operating or running scripts).

In step 423, the consumer may enter a tracking number, or other unique identifier, which identifies the article and/or parcel, into the confirmation app. For that purpose, the electronic device may be equipped with a scanning device which is capable of collecting and/or scanning (e.g., scanning a bar code or reading a QR code). Further, the electronic device may be capable of receiving and/or collecting a hand-typed tracking number or unique identifier (e.g., the consumer may use a key pad to type in the tracking number). Further, the confirmation app may provide a list of tracking numbers or unique identifiers to the consumer, and the consumer may select the appropriate tracking number, or unique identifier, from the list (e.g., a drop-down list).

In step 433, the confirmation app may validate the tracking number, or unique identifier, entered in step 423.

The confirmation app may be equipped with software code that performs this step automatically (e.g., without intervention from a human being). The tracking number, or unique identifier, entered in step 423 may be communicated by the confirmation app to a service provider system (e.g., service provider system 110 of FIG. 1). The service provider system may check, or compare, the tracking number, or unique identifier, to metadata received from a merchant (e.g., in step 362 of FIG. 3) or to metadata received from a transport service (e.g., in step 372 of FIG. 3) to validate the tracking number, or unique identifier. Thus, steps 362 and 372 of FIG. 3 may be performed prior to, or at the time the confirmation app communicates the tracking number, or unique identifier to the service provider system.

In step 443, the tracking number, or unique identifier, may be successfully validated. A valid tracking number, or unique identifier, may be found to match an existing tracking number, or unique identifier, in the metadata.

In step 453, the service provider system may log receipt of the article and/or parcel with the other metadata stored for that article, parcel, or transaction (e.g., creating a block of metadata and linking the block into the chain of metadata). The service provider system may log consumer receipt. The service provider system may log feedback from the consumer, merchant, manufacturer, transporter or other user. The metadata and/or the associated block chain may be correlated to a crypto token and/or reward (e.g., a crypto-currency). The crypto token may primarily be a utility token (e.g., used for rewards programs), rather than a security token (e.g., used as currency).

In step 463, the service provider system may assign one or more crypto tokens to the consumer's digital wallet (e.g., as a reward for participation and/or for using the confirmation app). Crypto tokens may be assigned to the consumer's digital wallet only upon successful validation of the tracking number, or unique identifier, as described in step 443.

In step 473, the tracking number, or unique identifier, may not be successfully validated. An invalid tracking number, or unique identifier, may not match any existing tracking number, or unique identifier, in the metadata.

Other aspects will be apparent to those skilled in the art from consideration of the specification and practice disclosed herein. It is intended, therefore, that the specification and illustrated embodiments be considered as examples only.

What is claimed is:

1. A confirmation system for confirming delivery of a parcel to a consumer, comprising:
a remote system for providing metadata corresponding to the parcel; and
a service provider system having storage for collecting the metadata from the remote system, wherein the service provider system is configured to receive metadata from the consumer to confirm delivery of the parcel.

2. The confirmation system of claim 1, wherein the metadata includes at least a unique identifier assigned to the parcel.

3. The confirmation system of claim 1, wherein the consumer sends metadata to the service provider system using an electronic device configured to collect the metadata.

4. The confirmation system of claim 3, wherein collecting the metadata includes one or more of manually entering a unique identifier, selecting a unique identifier from a list, scanning a bar code, and/or reading a QR code on the parcel.

5. The confirmation system of claim 1, wherein the service provider system receives metadata from the consumer and validates the metadata by comparing the metadata from the consumer to metadata from the remote system.

6. The confirmation system of claim 5, wherein the consumer receives a reward after the metadata from the consumer is validated against the metadata from the remote system.

7. The confirmation system of claim 1, wherein the reward is a crypto token having block chain, and wherein the metadata is written into the block chain of the crypto token.

8. The confirmation system of claim 1, wherein the remote system is one of a merchant system, a manufacturer system, a transport system, and/or a 3^{rd} party system.

9. A method of confirming delivery of a parcel to a consumer, comprising:
receiving metadata corresponding to the parcel from the consumer to a service provider system;
requesting and receiving metadata corresponding to the parcel from a merchant system to the service provider system; and
validating the metadata received from the merchant system against the metadata received from the consumer.

10. The method of claim 9, wherein the consumer sends metadata corresponding to the parcel to the service provider system with an electronic device configured to collect the metadata.

11. The method of claim 10, wherein collecting the metadata includes one or more of manually entering a unique identifier, selecting a unique identifier from a list, scanning a bar code, and/or reading a QR code on the parcel.

12. The method of claim 9, further including providing the consumer a reward after the metadata from the consumer is validated against the metadata from the merchant system.

13. The method of claim 12, wherein the reward is a crypto token having block chain, and wherein the metadata is written into the block chain of the crypto token.

14. The method of claim 9, further including requesting and receiving metadata corresponding to the parcel from a transport system to the service provider system.

15. A method of confirming delivery of a parcel to a consumer, comprising:
receiving metadata corresponding to the parcel from the consumer to a service provider system;
requesting and receiving metadata corresponding to the parcel from a transport system to the service provider system; and
validating the metadata received from the transport system against the metadata received from the consumer.

16. The method of claim 15, wherein the consumer sends metadata corresponding to the parcel to the service provider system with an electronic device configured to collect the metadata.

17. The method of claim 16, wherein collecting the metadata includes one or more of manually entering a unique identifier, selecting a unique identifier from a list, scanning a bar code, and/or reading a QR code on the parcel.

18. The method of claim 15, further including providing the consumer a reward after the metadata from the consumer is validated against the metadata from the merchant system.

19. The method of claim 18, wherein the reward is a crypto token having block chain, and wherein the metadata is written into the block chain of the crypto token.

20. The method of claim 15, further including requesting and receiving metadata corresponding to the parcel from a merchant system to the service provider system.
